(19) United States
(12) Patent Application Publication
(10) Pub. No.: US 2019/0385450 A1
(43) Pub. Date: Dec. 19, 2019

(54) METHOD AND APPARATUS FOR PROVIDING VIRTUAL TRAFFIC LIGHT SERVICE IN AUTOMATED VEHICLE AND HIGHWAY SYSTEMS

(71) Applicant: LG Electronics Inc., Seoul (KR)

(72) Inventor: Hansung KIM, Seoul (KR)

(21) Appl. No.: 16/557,287

(22) Filed: Aug. 30, 2019

(30) Foreign Application Priority Data
Jul. 31, 2019 (KR) 1020190093507

(51) Int. Cl. G08G 1/0967; G08G 1/0965; H04W 4/46

(52) U.S. Cl. CPC G08G 1/096708; H04W 4/46; G08G 1/0965

(57) ABSTRACT

Provided is a method for providing a virtual traffic light service to a first vehicle in automated vehicle & highway systems. The method includes receiving a reference message for generating virtual traffic light information, receiving a V2X message from a second vehicle or a road side unit (RSU) using V2X communication, determining whether the second vehicle enters an effective section, and generating the virtual traffic light information when the second vehicle enters the effective section. Accordingly, the first vehicle and the second vehicle can travel cooperatively. At least one of an autonomous vehicle, a user terminal, and a server of the present invention is associated with an artificial intelligence module, an unmmanned aerial vehicle (UAV) robot, an augmented reality (AR) device, a virtual reality (VR) device, and a device related to a 5G service.

### CROSS-REFERENCE TO RELATED APPLICATIONS

this application claims the benefit of Korean Patent Application No. 10-2019-0093507 filed on Jul. 31, 2019. The contents of this application are hereby incorporated by reference in its entirety.

### BACKGROUND OF THE INVENTION

### Field of the Invention

The present invention relates to automated vehicle & highway systems, and particularly, a method and an apparatus for generating a virtual traffic light and processing information of the virtual traffic light.

### Related Art

Vehicles can be classified into an internal combustion engine vehicle, an external composition engine vehicle, a gas turbine vehicle, an electric vehicle, etc. according to types of motors used therefor.

An autonomous vehicle refers to a self-driving vehicle that can travel without an operation of a driver or a passenger, and automated vehicle & highway systems refer to systems that monitor and control the autonomous vehicle such that the autonomous vehicle can perform self-driving.

### SUMMARY OF THE INVENTION

The present invention suggests a method and an apparatus for generating a virtual traffic light in automated vehicle & highway systems.

The present invention also suggests a method and an apparatus for generating a virtual traffic light and processing information of the virtual traffic light in the automated vehicle & highway systems.

Technical objects to be solved by the present invention are not limited to the technical objects mentioned above, and other technical objects that are not mentioned will be apparent to a person skilled in the art from the following detailed description of the invention.

In an aspect, a method for providing a virtual traffic light service to a first vehicle in automated vehicle & highway systems is provided. The method includes: receiving a reference message for generating virtual traffic light information; receiving a V2X message from a second vehicle or a road side unit (RSU) using V2X communication; determining whether the second vehicle enters an effective section requiring a travel using the virtual traffic light information, using the reference message or the V2X message; and generating of the virtual traffic light information when the second vehicle enters the effective section. The virtual traffic light information may include a traffic light signal for a cooperative travel of the first vehicle and the second vehicle in the effective section.

The reference message may include road information in the effective section, a priority value of a road based on the road information, information of a vehicle traveling in the effective section, a priority value of the vehicle traveling in the effective section, or policy information applied to the travel using the virtual traffic light information.

The priority value of the vehicle may be based on a reference point located in the effective section or a drive purpose of the vehicle.

When the first vehicle is a vehicle which does not support an autonomous traveling, the virtual traffic light information may be displayed for a user of the first vehicle.

The policy information may include first entering vehicle priority policy information that a vehicle first entering the effective section has priority, traffic flow improvement priority policy information for improving a traffic flow in the effective section, or emergency vehicle priority policy information that an emergency vehicle has priority.

When the policy information is the first entering vehicle priority policy information, the generating of the virtual traffic light information may include generating the virtual traffic light information including the traffic light signal for allowing a vehicle having a high priority value based on a road determined to be in a travelable status based on the road information to pass through the effective section first.

When the policy information is the traffic flow improvement priority policy information, the generating of the virtual traffic light information may include setting the priority value of a road such that the road requiring a traffic flow improvement based on the road information has priority, and generating the traffic light information including the traffic light signal for allowing a vehicle on the road having a high priority value based on the priority value of the road to pass through the effective section first.

When the second vehicle is determined to a vehicle which does not travel using the virtual traffic light information, through the V2X message, the first vehicle may urgently stop or a warning message may be displayed for a user of the first vehicle.

When the first vehicle travels in a state of a cluster, the effective section may indicate a section in which the first vehicle leaves from a cluster-traveling.

When a cluster-traveling is required for the first vehicle, the effective section may indicate a section joined to the cluster-traveling.

When the first vehicle travels in a state of a cluster, the priority value of the first vehicle may be based on the number of vehicles constituting the cluster for the cluster-traveling.

In another aspect, a method for providing a virtual traffic light service of a server in automated vehicle & highway systems is provided. The method includes: acquiring road information of a section monitored by the server through a reception of a request message of a virtual traffic light service from a vehicle or map information: determining whether to start the virtual traffic light service based on the request message or the road information; setting an effective section requiring a travel using virtual traffic light information for the virtual traffic light service; and transmitting a reference message for generating the virtual traffic light information. The reference message may be transmitted via a broadcast mode in the effective section.

The determining whether to start the virtual traffic light service may include determining the start of the virtual traffic light service when an intersection section, a ramp section, or a construction section occurs based on the road information, or when an operation for a cluster-traveling of the vehicle occurs based on the request message.

The operation for the cluster-traveling of the vehicle may include an operation when a cluster to which the vehicle belongs passes through an intersection or an operation when the cluster changes a lane.

The reference message may include road information in the effective section, a priority value of a road based on the road information, information of a vehicle traveling in the effective section, a priority value of the vehicle traveling in the effective section, or policy information applied to the travel using the virtual traffic light information.

The priority value of the vehicle may be based on a reference point located in the effective section or a drive purpose of the vehicle.

The server may include a host vehicle including an application executing the virtual traffic light service.

The method may further include receiving a V2X message using V2X communication from the vehicle through a PC5: updating the reference message based on the V2X message; and transmitting the updated reference message, and the V2X message may include status information of the vehicle or road information in the effective section.

The transmitting the reference message may include transmitting the reference message while a vehicle traveling the effective section exists.

In still another aspect, a server for providing a virtual traffic light service of the server in automatic vehicle & highway systems is provided. The server includes: a communication module; a memory; and a processor, the processor receives a request message of the virtual traffic light service from a vehicle using the communication module or acquires road information of a section monitored by the server through map information, determines whether to start the virtual traffic light service based on the request message or the road information, sets an effective section requiring a travel using virtual traffic light information through the virtual traffic light service, and transmits a reference message for generating the virtual traffic light information, and the reference message may include road information of the effective section.

### BRIEF DESCRIPTION OF THE DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 shows a vehicle according to an embodiment of the present invention.

FIG. 6 is a control block diagram of the vehicle according to an embodiment of the present invention.

FIG. 7 is a control block diagram of an autonomous device according to an embodiment of the present invention.

FIG. 8 is a diagram showing a signal flow in an autonomous vehicle according to an embodiment of the present invention.

FIG. 9 is a diagram referred to describe a usage scenario of a user according to an embodiment of the present invention.

FIG. 10 is an example of V2X communication to which the present invention is applicable.

FIG. 11 shows a resource allocation method in a side-link where the V2X is used.

FIG. 12 is a diagram showing a procedure for the broadcast mode of V2X communication using a PC5.

FIG. 13 is an example of a reference message processing process to which the present invention is applicable.

FIG. 14 is an example of the reference message processing process to which the present invention is applicable.

FIG. 15 is an embodiment to which the present invention is applicable.

FIG. 16 is an example of a virtual traffic light information generation to which the present invention is applicable.

FIG. 17 is an example of the virtual traffic light information generation to which the present invention is applicable.

FIG. 18 is an embodiment to which the present invention is applicable.

FIG. 19 is an embodiment to which the present invention is applicable.

FIG. 20 is an embodiment to which the present invention is applicable.

FIG. 21 is an embodiment in which virtual traffic light information is transmitted through a server at an intersection.

FIG. 22 is an embodiment in which virtual traffic light information is transmitted through a host vehicle at the intersection.

FIG. 23 is a diagram showing a configuration of a server to which the present invention is applied.

The accompanying drawings, which are included as a part of detailed descriptions to aid understanding of the present invention, provide an embodiment of the present invention and, together with the detailed description, explain technical features of the present invention.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

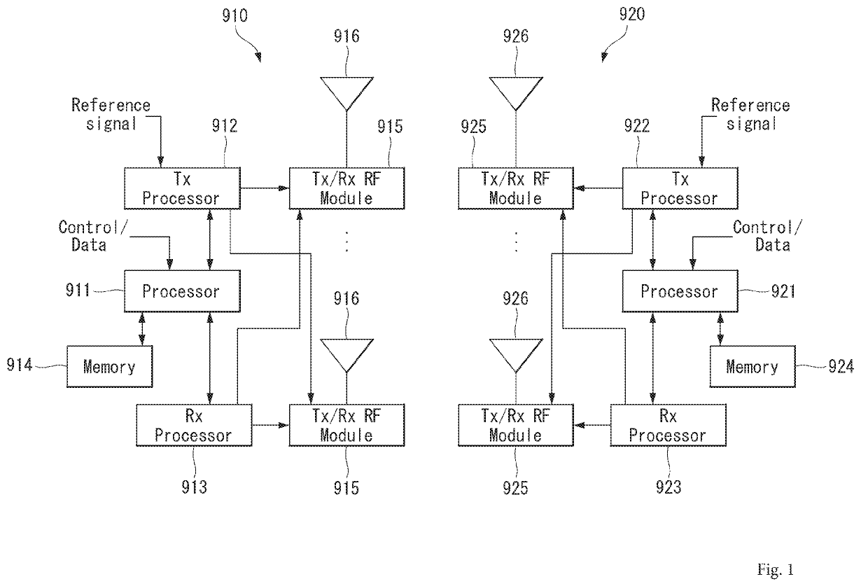

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

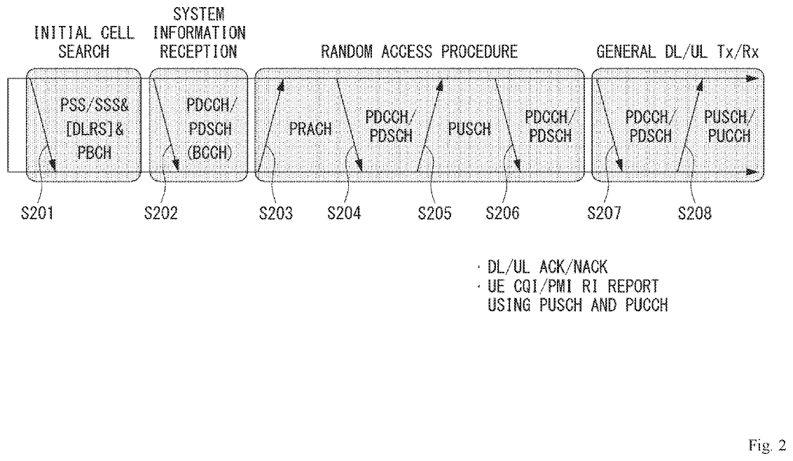

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SysteminformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz. 30 kHz. 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent path loss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.
When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

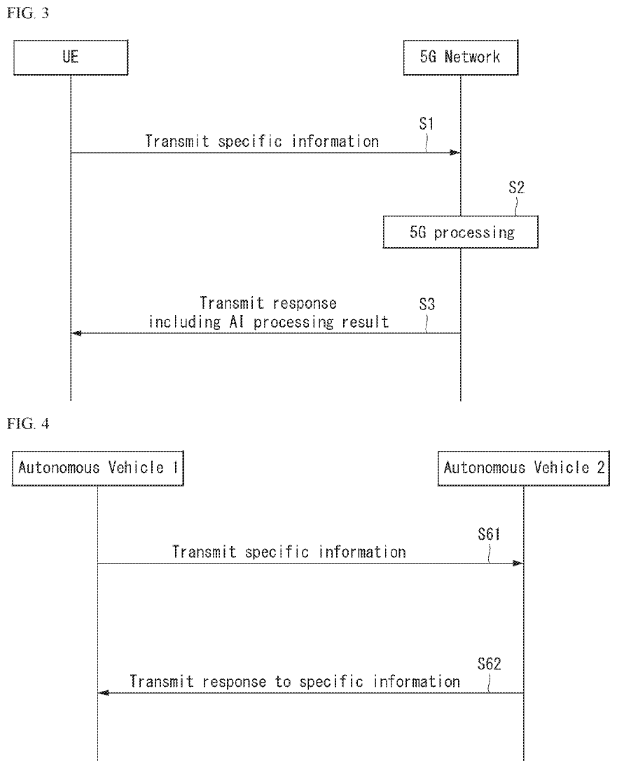

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (side-link communication transmission mode 3) or indirectly (side-link communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical side-link control channel (PSCCH) is a 5G physical channel for scheduling of transmission of specific information a physical side-link shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

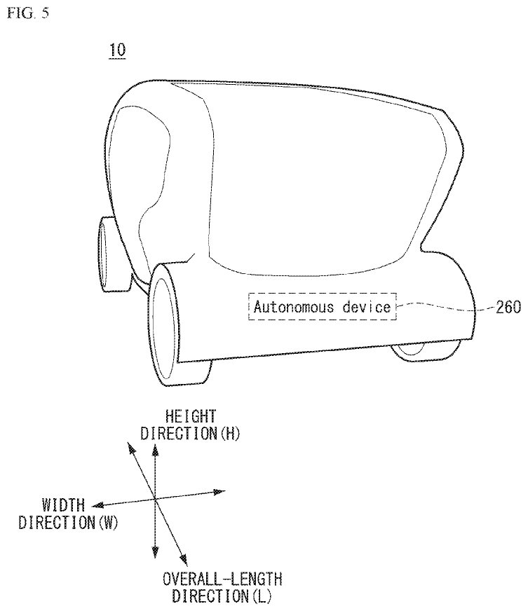

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

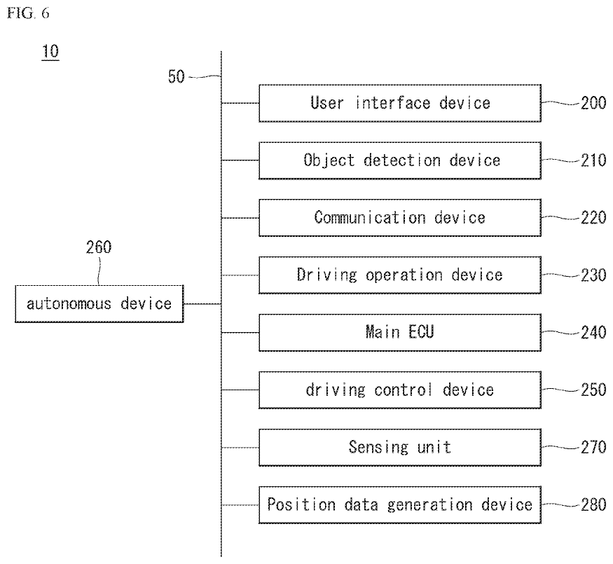

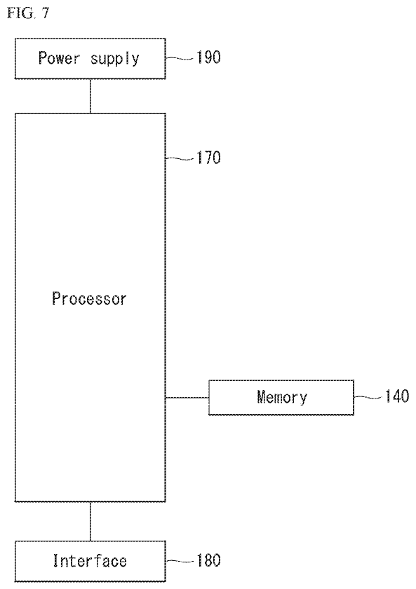

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include side-link communication based on LTE and/or side-link communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control). AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

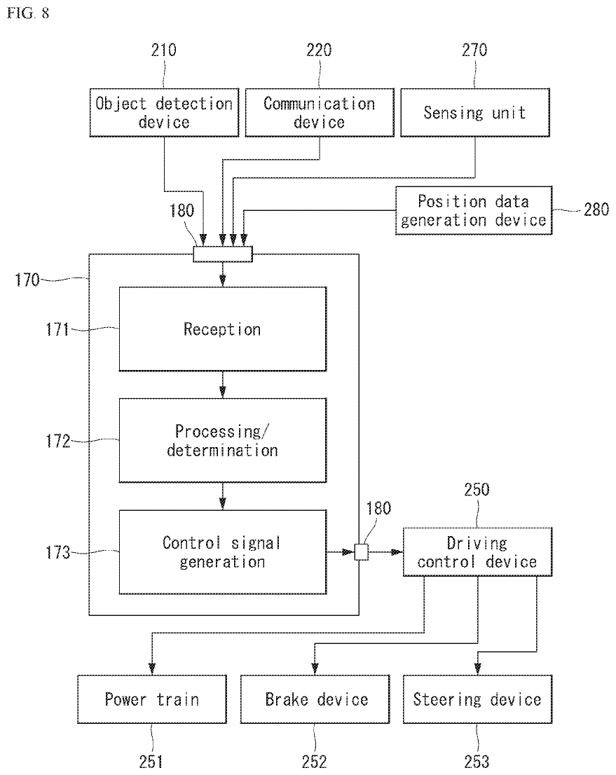

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data. HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 253.

Autonomous Vehicle Usage Scenario

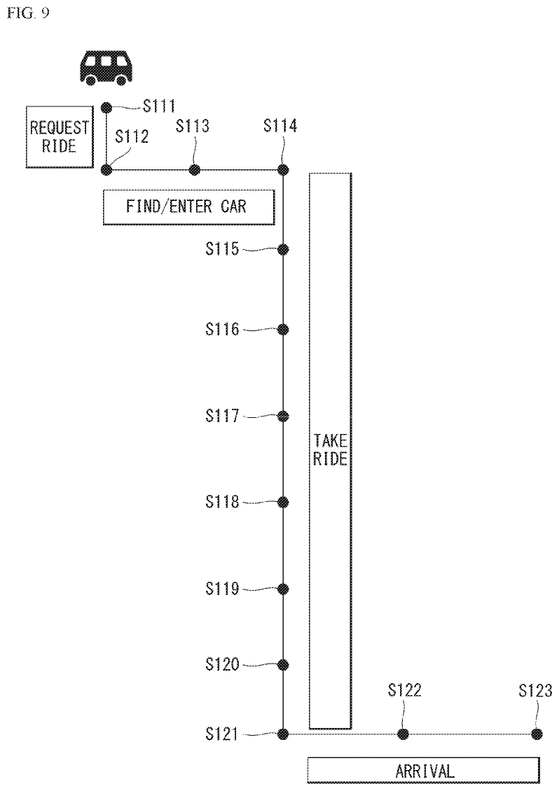

FIG. 9 is a diagram referred to describe a usage scenario of the user according to an embodiment of the present invention.

1) Destination Forecast Scenario

A first scenario S111 is a destination forecast scenario of the user. A user terminal may install an application that can be linked with a cabin system 300. The user terminal can forecast the destination of the user through the application based on user's contextual information. The user terminal may provide vacant seat information in a cabin through the application.

2) Cabin Interior Layout Countermeasure Scenario

A second scenario S112 is a cabin interior layout countermeasure scenario. The cabin system 300 may further include a scanning device for acquiring data on the user located outside a vehicle 300. The scanning device scans the user and can obtain physical data and baggage data of the user. The physical data and baggage data of the user can be used to set the layout. The physical data of the user can be used for user authentication. The scanning device can include at least one image sensor. The image sensor can use light in a visible light band or an infrared band to acquire an image of the user.

The seat system 360 can set the layout in the cabin based on at least one of the physical data and baggage data of the user. For example, the seat system 360 may provide a baggage loading space or a seat installation space.

3) User Welcome Scenario

A third scenario S113 is a user welcome scenario. The cabin system 300 may further include at least one guide light. The guide light may be disposed on a floor in the cabin. The cabin system 300 may output the guide light such that the user is seated on the seat, which is already set among the plurality of sheets when user's boarding is detected. For example, a main controller 370 may implement moving light through sequential lighting of a plurality of light sources according to the time from an open door to a predetermined user seat.

4) Seat Adjustment Service Scenario

A fourth scenario S114 is a seat adjustment service scenario. The seat system 360 may adjust at least one element of the seat that matches the user based on the acquired physical information.

5) Personal Content Provision Scenario

A fifth scenario S115 is a personal content provision scenario. A display system 350 can receive personal data of the user via an input device 310 or a communication device 330. The display system 350 can provide a content corresponding to the personal data of the user.

6) Product Provision Scenario

A sixth scenario S116 is a product provision scenario. A cargo system 355 can receive user data through the input device 310 or the communication device 330. The user data may include preference data of the user and destination data of the user. The cargo system 355 may provide a product based on the user data.

7) Payment Scenario

A seventh scenario S117 is a payment scenario. A payment system 365 can receive data for price calculation from at least one of the input device 310, the communication device 330 and the cargo system 355. The payment system 365 can calculate a vehicle usage price of the user based on the received data. The payment system 365 can require the user (that is, mobile terminal of user) to pay a fee at the calculated price.

8) User Display System Control Scenario

An eighth scenario S118 is a user display system control scenario. The input device 310 may receive a user input configured in at least one form and may convert the user input into an electrical signal. The display system 350 can control a content displayed based on the electrical signal.

9) AI Agent Scenario

A ninth scenario S119 is a multi-channel artificial intelligence (AI) agent scenario for multiple users. An AI agent 372 can distinguish the user input of each of multiple users. The AI agent 372 can control at least one of the display system 350, the cargo system 355, the seat system 360, and the payment system 365 based on the electric signal converted from the user input of each of the multiple users.

10) Multimedia Content Provision Scenario for Multiple Users

A tenth scenario S120 is a multimedia content provision scenario for multiple users. The display system 350 can provide a content that all users can view together. In this case, the display system 350 can individually provide the same sound to multiple users through a speaker provided in each sheet. The display system 350 can provide a content that the multiple users individually can view. In this case, the display system 350 can provide an individual sound through the speaker provided in each sheet.

11) User Safety Securing Scenario

An eleventh scenario S121 is a user safety securing scenario. When vehicle peripheral object information that poses a threat to the user is acquired, the main controller 370 can control to output an alarm of the vehicle peripheral object via the display system 350.

12) Belongings Loss Prevention Scenario

A twelfth scenario S122 is a scenario for preventing loss of belongings of the user. The main controller 370 can obtain data on the belongings of the user via the input device 310. The main controller 370 can obtain user motion data through the input device 310. The main controller 370 can determine whether the user places the belongings and gets off based on the data of the belongings and the motion data. The main controller 370 can control to output an alarm of the belongings through the display system 350.

13) Get Off Report Scenario

A thirteenth scenario S123 is a get off report scenario. The main controller 370 can receive get off data of the user through the input device 310. After the user gets off, the main controller 370 can provide report data for the get off to the mobile terminal of the user through the communication device 330. The report data may include the entire usage fee data of the vehicle 10.

Vehicle-to-Everything (V2X)

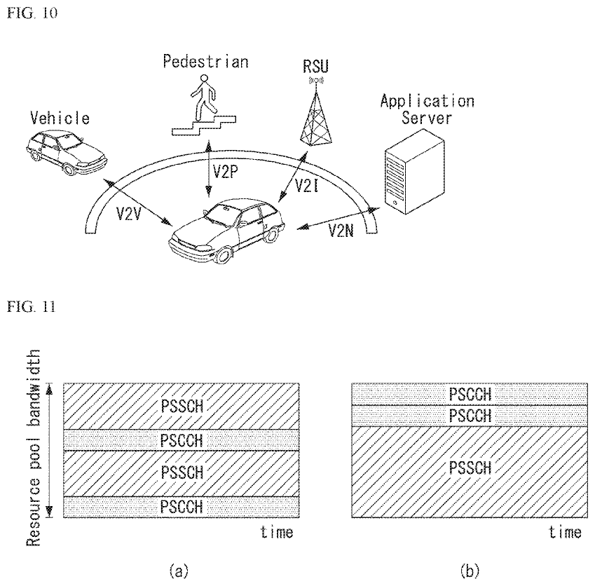

FIG. 10 is an example of V2X communication to which the present invention is applicable.

The V2X communication includes communication between a vehicle and all objects such as Vehicle-to-Vehicle (V2V) referring to communication between vehicles, Vehicle-to-Infrastructure (V2I) referring to communication between a vehicle and an eNB or a Road Side Unit (RSU), and Vehicle-to-Pedestrian (V2P) or a Vehicle-to-Network (V2N) referring to communication between a vehicle and a UE with an individual (pedestrian, bicycler, vehicle driver, or passenger).

The V2X communication may indicate the same meaning as V2X side-link or NR V2X, or may include a broader meaning including the V2X side-link or NR V2X.

For example, the V2X communication can be applied to various services such as forward collision warning, an automatic parking system, a cooperative adaptive cruise control (CACC), control loss warning, traffic matrix warning, traffic vulnerable safety warning, emergency vehicle warning, speed warning on a curved road, or a traffic flow control.

The V2X communication can be provided via a PC5 interface and/or a Uu interface. In this case, in a wireless communication system that supports the V2X communication, there may exist a specific network entity for supporting the communication between the vehicle and all the objects. For example, the network object may be a BS (eNB), the road side unit (RSU), a UE, an application server (for example, a traffic safety server), or the like.

In addition, the UE executing V2X communication includes not only a general handheld UE but also a vehicle UE (V-UE), a pedestrian UE, a BS type (eNB type) RSU, a UE type RSU, a robot having a communication module, or the like.

The V2X communication may be executed directly between UEs or may be executed through the network object(s). V2X operation modes can be divided according to a method of executing the V2X communication.

The V2X communication requires a support for UE pseudonymity and privacy when a V2X application is used so that an operator or a third party cannot track a UE identifier within a V2X support area.

Terms frequently used in the V2X communication are defined as follows.
Road Side Unit (RSU): The RSU is a V2X serviceable device that can perform transmission/reception with a moving vehicle using a V2I service. Furthermore, the RSU can exchange messages with other entities supporting the V2X application as a fixed infrastructure entity supporting the V2X application. The RSU is a term often used in the existing ITS specifications, and a reason for introducing this term in 3GPP specifications is to make it easy to read a document in an ITS industry. The RSU is a logical entity that combines a V2X application logic with functions of a BS (referred to as BS-type RSU) or a UE (referred to as UE-type RSU).
V2I service: A type of V2X service in which one is a vehicle and the other is an entity belongs to an infrastructure.
V2P service: A type of the V2X service in which one is a vehicle and the other is a device (for example, handheld UE carried by pedestrian, bicycler, driver, or passenger) carried by an individual.
V2X service: A 3GPP communication service type in which a transmitting or receiving device is related to a vehicle.
V2X enabled UE: A UE supporting the V2X service.
V2V service: A type of the V2X service in which both in the communication are vehicles.
V2V communication range: A range of direct communication between two vehicles participating in the V2V service.

As described above, the V2X application referred to as the V2X (Vehicle-to-Everything) includes four types such as (1) Vehicle-to-Vehicle (V2V), (2) Vehicle-to-infrastructure (V2I), (3) Vehicle-to-Network (V2N), and (4) Vehicle-to-Pedestrian (V2P).

FIG. 11 shows a resource allocation method in a side-link where the V2X is used.

In the side-link, different physical side-link control channels (PSCCHs) may be separately allocated in a frequency domain, and different physical side-link shared channels (PSSCHs) may be separately allocated. Alternatively, different PSCCHs may be allocated consecutively in the frequency domain, and PSSCHs may also be allocated consecutively in the frequency domain.

NR V2X

In order to extend a 3GPP platform to a vehicle industry during 3GPP release 14 and 15, supports for the V2V and V2X services are introduced in LTE.

Requirement for supports with respect to an enhanced V2X use case are broadly divided into four use case groups.

(1) A Vehicle Platooning can dynamically form a platoon in which vehicles move together. All vehicles in the platoon get information from the top vehicle to manage this platoon. These pieces of information allow the vehicles to be operated in harmony in the normal direction and to travel together in the same direction.

(2) Extended sensors can exchange raw data or processed data collected by a local sensor or a live video image in a vehicle, a road site unit, a pedestrian device, and a V2X application server. In the vehicle, it is possible to raise environmental awareness beyond what a sensor in the vehicle can sense, and to ascertain broadly and collectively a local situation. A high data transmission rate is one of main features.

(3) Advanced driving allows semi-automatic or full-automatic driving. Each vehicle and/or the RSU shares own recognition data obtained from the local sensor with a proximity vehicle and allows the vehicle to synchronize and coordinate a trajectory or maneuver. Each vehicle shares a driving intention with the proximity vehicle.

(4) Remote driving allows a remote driver or the V2X application to drive the remote vehicle for a passenger who cannot drive the remote vehicle in his own or in a dangerous environment. If variability is restrictive and a path can be forecasted as public transportation, it is possible to use Cloud computing based driving. High reliability and a short waiting time are important requirements.

Broadcast Mode

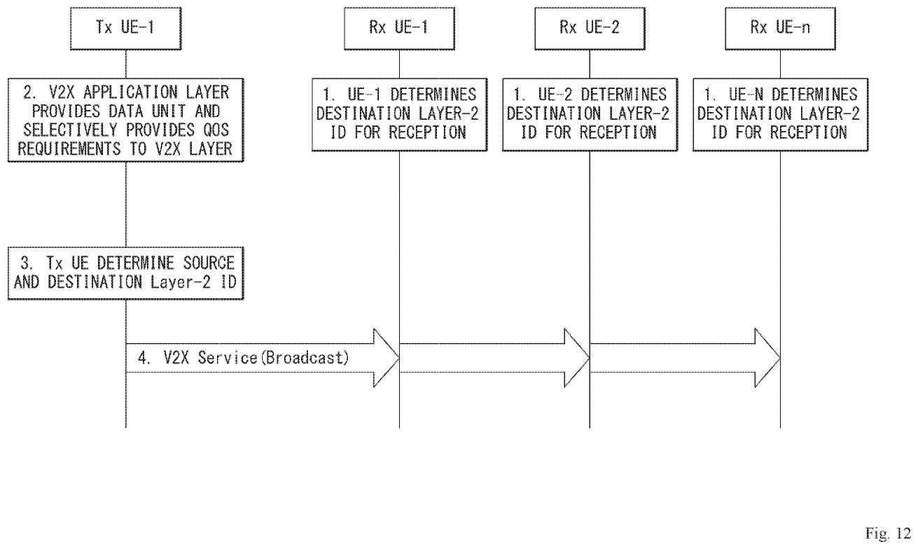

FIG. 12 is a diagram showing a procedure for the broadcast mode of V2X communication using a PC5.

A receiving terminal determines a destination Layer-2 ID for a broadcast reception. The destination Layer-2 ID is transmitted to an AS layer of the receiving terminal for the reception.

2. A V2X application layer of a transmitting terminal can provide a data unit and can provide V2X application requirements.

3. The transmitting terminal determines the destination Layer-2 ID for broadcasting. The transmitting terminal self-assigns a source Layer-2 ID.

4. One broadcast message transmitted by the transmitting terminal transmits V2X service data using the source Layer-2 ID and the destination Layer-2 ID.

The above-described 5G communication technology can be applied in combination with methods proposed in the present invention described later or can be supplemented to embody or clarify technical features of methods proposed in the present invention.

Driving assistance information (for example, a driving warning message) which provided via sensing data of a sensor in the automated vehicle & highway systems disperses a user's gaze, which may cause a dangerous situation. A service such as a green light optimal speed advisory (GLOSA) using the RSU is dependent on the RSU and is not supported on a road section without the RSU.

A traffic light is a device which is installed on an intersection or a crosswalk on a road and instructs a passing vehicle or a person to stop, bypass, progress, or the like by flashing red, green, yellow, and green arrow indicators.

In the present invention, in a section where the traffic light is required such as a section without the traffic light, virtual traffic light information is generated, a traveling situation is determined based on map information and a V2X message, and the generated virtual traffic light information is transmitted to vehicles exiting in the section to control a traffic flow. Thus, a reference message that can be shared via the V2X communication generates the virtual traffic light information that can be used for each vehicle based on a V2V message including a state of each vehicle and detection information. In addition, the virtual traffic light information, traveling assistance information, or the like is provided to the user of each vehicle.

By using the present invention, the vehicle can be guided to be able to drive to avoid a risk of collision, and even on a road section without infrastructure such as the RSU, the virtual traffic light information, the traveling assistance information, or the like can be provided. In addition, even on a road section with infrastructure, the vehicle can be guided to be safely driven in consideration of a current traffic condition.

In the present invention, the autonomous vehicle does not refer to a specific vehicle, but is divided into levels 1 to 3 (partially autonomous) and levels 4 to 5 (fully autonomous) according to an autonomous traveling function provided.

The virtual traffic light information is displayed on a road where a vehicle that does not support autonomous traveling and a vehicle that supports the autonomous traveling are mixed, the virtual traffic light information is provided to the user or directly input to an algorithm for the traveling of the autonomous vehicle, and it is possible to control the traffic flow through a cooperative traveling.

Therefore, the present invention provides a method for generating and processing the virtual traffic light information through a network supported by the V2X communication such that the vehicles can cooperatively travel when an order determination with respect to entrance/exit between the vehicles is required under vehicle status information (for example, speed, position, or the like), the map information, and traffic regulations in a section in which the traffic light actually exists or a section in which the traffic light does not actually exist.

Reference Message and Map Information

The reference message and the map information for the present invention can be generated by the vehicle 10 or generated via the server and can be transmitted to the vehicle 10. The reference message may include a first reference message generated by the vehicle 10 and a second reference message generated by the server, and the first reference message is self-generated when the vehicle 10 executes the role of the server or is received through other vehicles when the vehicle 10 does not execute the role of the server and can be generated by the second reference message received from the server. Also, unlike the second reference message, the first reference message may include a request message for the virtual traffic light service. For example, the reference message and the map information can include the following information.

1. Reference Message
Dynamic information including road information and, the number of waiting vehicles for each lane with respect to the virtual traffic light information effective section
Priority value of vehicle for virtual traffic light information generation
Policy information for entrance/exit or the like (for example, first entering vehicle priority, traffic flow improvement priority, emergency vehicle priority)
Traveling permission information for each lane determined dynamically (for example, straight for each lane, right turn permission information, and right turn permission information)
Priority value for road or lane dynamically determined (can be determined dynamically according to the entrance/exit policy information)
Defective vehicle information (This has a purpose to propagate information on a vehicle that is not driven based on the virtual traffic light information to the autonomous vehicles within the virtual traffic light effective section)

2. Map Information
Information for determining whether a road section located on a traveling route of the vehicle 10 is a section requiring the virtual traffic light information
Information for generating road information included in the reference message

In addition, the V2X message described in the present invention may mean a 3GPP-defined V2X message transmitted using the V2X communication via the PC5 interface, and may include the status information of the vehicle 10, control information, position information, sensing information, or the like. The V2X message can be transmitted to the server or peripheral vehicles through a broadcast message method, and for example, may have a transmission frequency of 30 per second for communication between vehicles in a cluster or a transmission frequency of 50 per second for communication with the RSU.

The reference message or the map information can be generated and updated based on information obtained via the V2X message.

Virtual Traffic Light Information Valid Interval

The virtual traffic light information effective section exemplified in the present invention may be set in a case where the vehicle 10 enters a specific section or in a case where it is necessary to determine an entrance/exit order between vehicles through a traveling status.

The map information or the reference message is used to set the virtual traffic light information effective section.

For example, an effective section candidate can be defined as an intersection, a ramp section, a construction section, and a cluster traveling (for example, when lane change, intersection passage, and cluster generation/release/join/leave event are generated) which can be determined via the road information or the first message received from the vehicle. The effective section can be set to a certain range from the effective section candidates. For example, the effective section may be set to a radius of 100 m from a center point of a location of the effective section candidate determined through the road information or the first reference message. However, the effective section varies according to the traffic situation. For example, in a case where a road in the effective section is a highway or a road on which many vehicles travel, or in a case where a high degree of attention of the user is required according to a road environment (that is, rain, snow, night), a predetermined range is widened.

Virtual Traffic Light Information Processing Method

A first vehicle 10, which initially recognizes entering a section requiring the virtual traffic light information, transmits a virtual traffic light service start request message to the connected server. Alternatively, the server may start the virtual traffic light service based on the map information and the second reference message related to the monitored section. Accordingly, when the virtual traffic light service starts, the section requiring the virtual traffic light information can be set as the virtual traffic light information effective section.

If there is no server connected to the vehicle 10, the first vehicle 10 can execute the role of the server. If vehicle 10, which executes the role of the server, deviates from the virtual traffic light information effective section, the role of server can be assigned to the subordinate vehicle.

The server transmits the reference message for the virtual traffic light information generation while the vehicles 10 travel in the virtual traffic light information effective section or the effective section. The reference message is generated according to a policy which is preset in the server or the vehicle executing the role of the server.

The vehicles 10 entering the virtual traffic light information effective section update the status information of the vehicle through the server, and if the update is completed, the status information is reflected to the reference message.

The reference message is transmitted into the effective section according to a virtual traffic light information generation method described later, and the vehicle 10 can generate and use the virtual traffic light information including the traffic light signal having the priority value in the reference message, using the received the reference message.

Priority Ranking for Virtual Traffic Light Information Generation

For example, the priority values of the vehicle for generating the virtual traffic light information are as follows.

1. A vehicle which is located close to a reference point in the virtual traffic light effective section

2. A vehicle which is expected to arrive at the reference point in the virtual traffic light effective section first

3. A priority ranking according to a type of a vehicle (for example, a general vehicle, a specific vehicle including an emergency vehicle, or the like) set in the virtual traffic light effective section

The reference point may be set initially or dynamically according to a road environment.

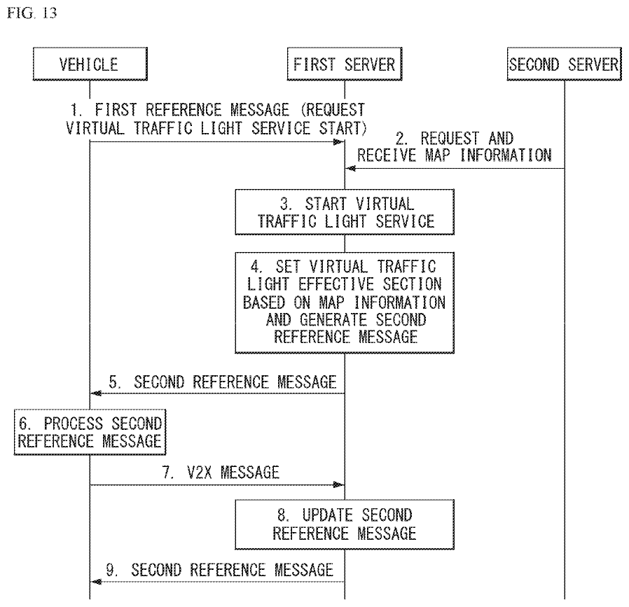

FIG. 13 is an example of a reference message processing process to which the present invention is applicable.

The vehicle 10 is connected to a first server or a second server and can execute the V2X communication through the PC5 interface. The first server may include an application for the virtual traffic light service, and the second server may include a data base which manages the map information for the virtual traffic light service. The first server and the second server may physically constitute one server, and the second server may be connected to the vehicle 10 to transmit or receive the data when the vehicle 10 executes the role of the first server.

1. The vehicle 10 transmits the first reference message to the first server. The first reference message may include the virtual traffic light service start request message when a traveling section in the vehicle 10 is determined to a section requiring the virtual traffic light service.

For example, while a vehicle initially approaching the virtual traffic light effective section passes through the section, the vehicle can determine whether one or more vehicles approach the effective section based on the V2X message, and in a case where approaching of other vehicles is expected, the vehicle may receive the virtual traffic light service request message.

The first reference message may be generated based on sensing data of the vehicle 10 or received from other vehicles.

2. The first server requests the map information tom the second server and receive the map information.

3. When the first server receives the first reference message, the virtual traffic light service starts based on the first reference message. Alternatively, the virtual traffic light service starts through the acquired road information based on the map information. When the first reference message is not received from the vehicle 10, the first server may not execute the step of 1.

4. The first server sets the virtual traffic light effective section based on the first reference message and the map information, and generates the second reference message for the virtual traffic light service in the virtual traffic light effective section.

5. The first server transmits the second reference message so as to provide the virtual traffic light service to the vehicle 10.

6. The vehicle 10 may perform autonomous traveling based on the received second reference message or provide information on the second reference message to the user.

7. The vehicle 10 transmits the V2X message including the status information related to the traveling to the first server through the V2X communication using the PC5.

8. The first server updates the second reference message based on the received V2X message.

9. The first server transmits the updated second reference message to the vehicle 10.

The steps of 7 to 9 may be executed repeatedly until it is determined that the first server does not need to provide the virtual traffic light service to the vehicle 10 based on the V2X message.

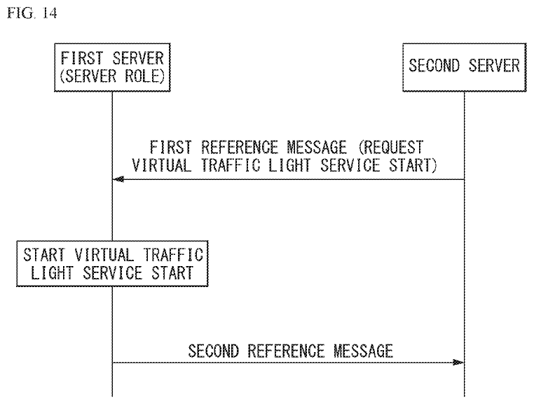

FIG. 14 is an example of the reference message processing process to which the present invention is applicable.

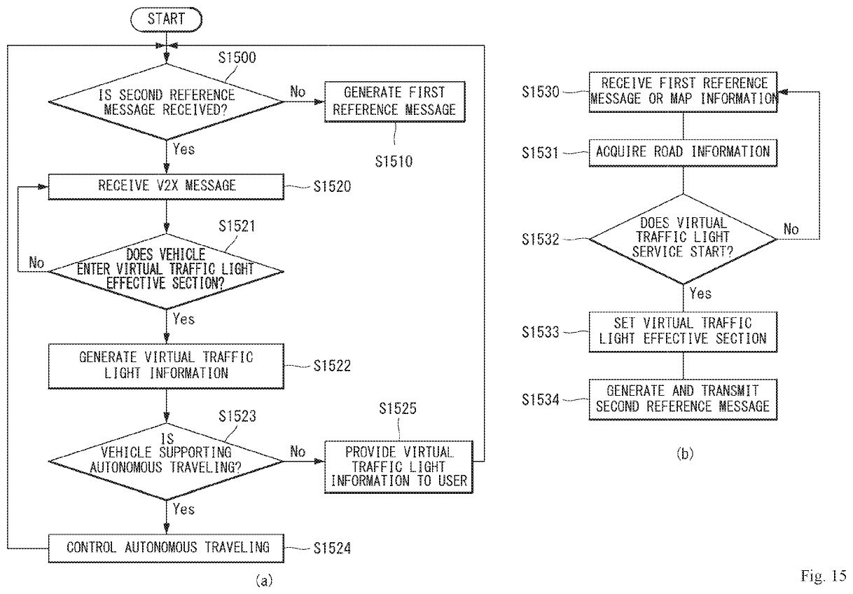

Unlike the example of FIG. 15, in a case where the role of the server is assigned to the vehicle 10, the virtual traffic light service for the second vehicle may start when the first vehicle receives the first reference message including the virtual traffic light service start request message from the second vehicle or may start by self-determination of the first vehicle. Hereinafter, the reference message may be provided to the second vehicle through a similar operation as that of FIG. 15.

FIG. 15 is an embodiment to which the present invention is applicable.

FIG. 15A is an example for executing the virtual traffic light service of the vehicle.

The vehicle may receive the second reference message from the server (S1500).

When the vehicle receives the second reference message, the vehicle receives the V2X message including traveling information of the peripheral vehicle (S1520).

Whether other vehicles enter the virtual traffic light effective section indicated by the second reference message is determined by the RSU, the map information, or the like (S1521).

In addition, a construction section, an accident section, and traffic jam which are not displayed on the map information, presence or absence of the traffic light, or the like are acquired using the V2X message or a sensor (radar, camera, lidar, or the like) located in the effective section and are used.

The virtual traffic light information is generated (S1522). The virtual traffic light information include the traffic light signal determined through the priority value in the second reference message. That is, in vehicles in a competitive relationship, through the priority value, a vehicle having a high priority ranking has a blue traffic light signal, and a vehicle having a low priority ranking has a red traffic light signal.

It is determined whether the vehicle 10 is a vehicle supporting the autonomous traveling (S1523).

If the vehicle 10 is the vehicle supporting the autonomous traveling, the server may control the autonomous traveling using the virtual traffic light information and may transmit the virtual traffic light information to other vehicles (S1524).

If the vehicle 10 is not the vehicle supporting the autonomous traveling, the vehicle may provide the virtual traffic light information to the user (S1525).

The virtual traffic light information may be generated for each vehicle, the virtual traffic light information generated by a specific vehicle may be shared, and the virtual traffic light information may be generated by the server and shared.

FIG. 15B is an example for executing a virtual service in a server or a host vehicle. As described above, in the present invention, the host vehicle may execute the role of the server.

The server can acquire the map data through other servers or a data base of the server or can receive the first reference message from the vehicle (S1530).

The server acquires road information on the virtual traffic light information effective sections through the map information (S1531).

Whether the virtual traffic light service should be started is determined based on the road information or the first reference message (S1532). This may be determined by whether the above-described effective section candidate is present.

When it is determined that the virtual traffic light service should be started, the virtual traffic light effective section is set (S1533). A set range of the effective section may be variable according to a peripheral traffic situation (for example, a speed of a peripheral vehicle, the number of the peripheral vehicles).

The second reference message for the virtual traffic light information is generated and transmitted (S1534). The road information, the priority value of the vehicle, or the like for the virtual traffic light effective section may be provided to other vehicles through the second reference message. The vehicle generates the virtual traffic light information based on the second reference message.

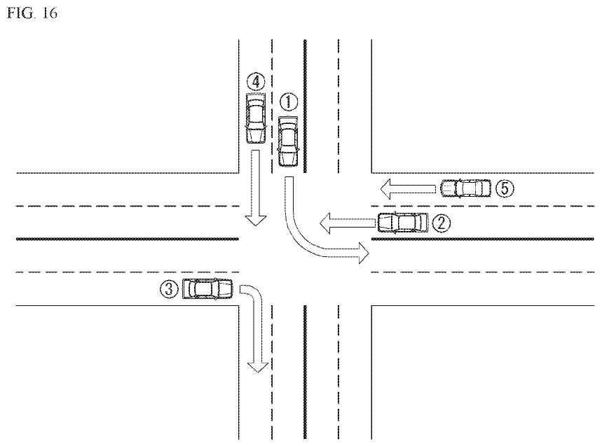

FIG. 16 is an example of the virtual traffic light information generation to which the present invention is applicable.

With reference to FIG. 16, the priority values assigned to the respective roads in a policy of the first entering vehicle priority are the same as each other. The priority rankings of the vehicles in the effective section are determined according to an order of vehicles located close to the reference point in the virtual traffic light effective section.

A general vehicle may have the same priority value. However, in a case of a cluster traveling, as the number of the vehicles forming a cluster increase, a high priority value is assigned.

The virtual traffic light information may be generated according to the following sequence.

(1) First, only roads in a travelable status are considered based on the road information in the reference message.

(2) If an object (for example, pedestrian or bicycle) other than the vehicle 10 is detected on a road in the virtual traffic light effective section, the road may be set as a traveling impossible status until the object is removed.

(3) The virtual traffic light information is generated according to the policy information in consideration of the priority values of the vehicles traveling on the road in the travelable status.

Here, the reference point may be a center of the intersection, the priority values of the respective vehicles are set with reference to the reference point, and the vehicles are controlled such that the vehicles pass through the intersection in an order of higher priority value based on the priority values.

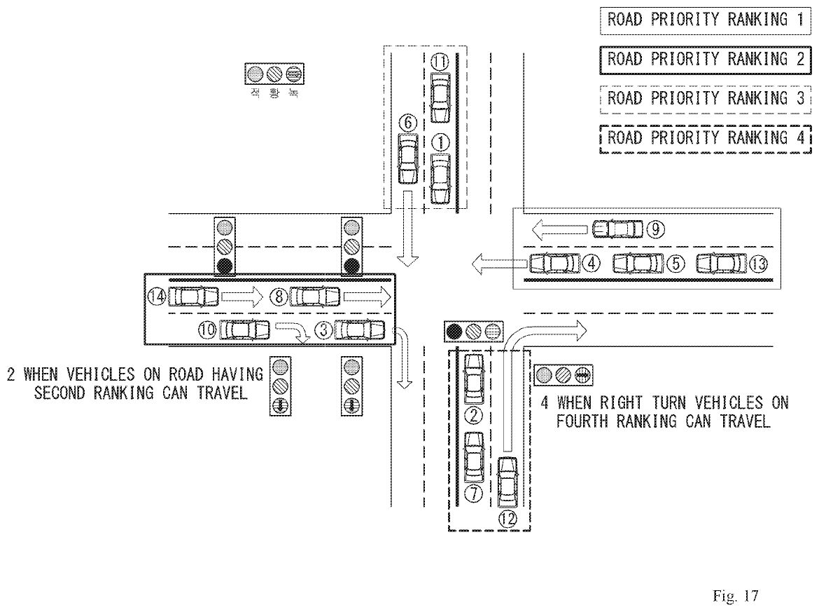

FIG. 17 is an example of the virtual traffic light information generation to which the present invention is applicable.

With reference to FIG. 17, when a traffic flow priority policy is applied, the priority value may be set to each road or lane. While a first entering vehicle priority policy may be used when the number of the vehicles traveling on each road is small (for example, when two or less vehicle travel on each road), a traffic flow priority policy may be applied when a traffic flow improvement in the effective section is necessary. The priority values for the road and lane may be updated periodically by the server.

In the present invention, when the traveling routes between specific roads and lanes collide with each other, the roads or lanes may be defined as being in a competitive relationship. In the roads or the lanes in the competitive relationship, the priority rankings are determined according to the priority values. However, even when the road or the lane has a low priority ranking, in a case where there is no vehicle traveling the road or the lane having a high priority ranking in the competitive relationship, the vehicle on the road or lane having a second priority ranking can travel.

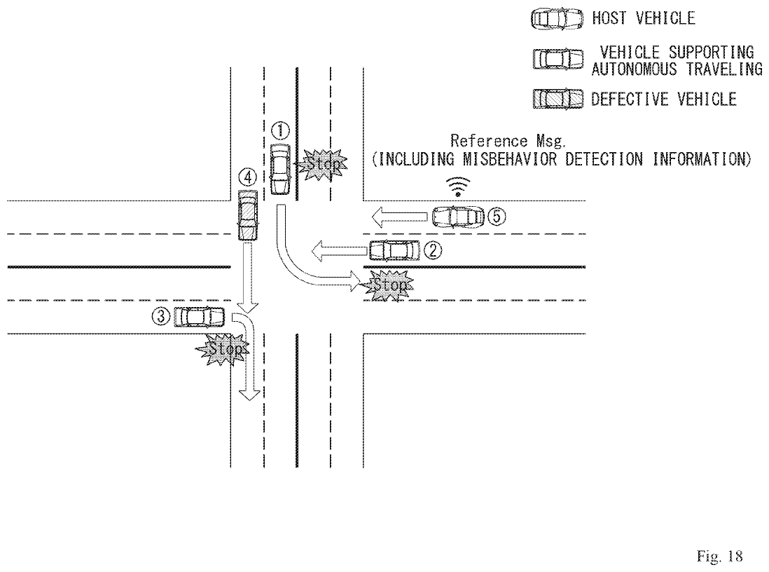

FIG. 18 is an embodiment to which the present invention is applicable.

When the vehicle traveling the virtual traffic light effective section detects a defective vehicle, the vehicle transmits this to the server through the V2X message or the host vehicle can directly detect this. Here, the defective vehicle means a vehicle which does not travel the effective section according to the virtual traffic light information or a vehicle which cannot travel the effective section.

When the vehicle in the effective section is the vehicle supporting the autonomous traveling, the vehicle can automatically stop to avoid a risk, and when the vehicle is not the autonomous vehicle, the vehicle can provide a warning message to the user.

If the defective vehicle is the vehicle supporting the autonomous traveling, the server or the host vehicle can move the defective vehicle to a safe position through a remote control.

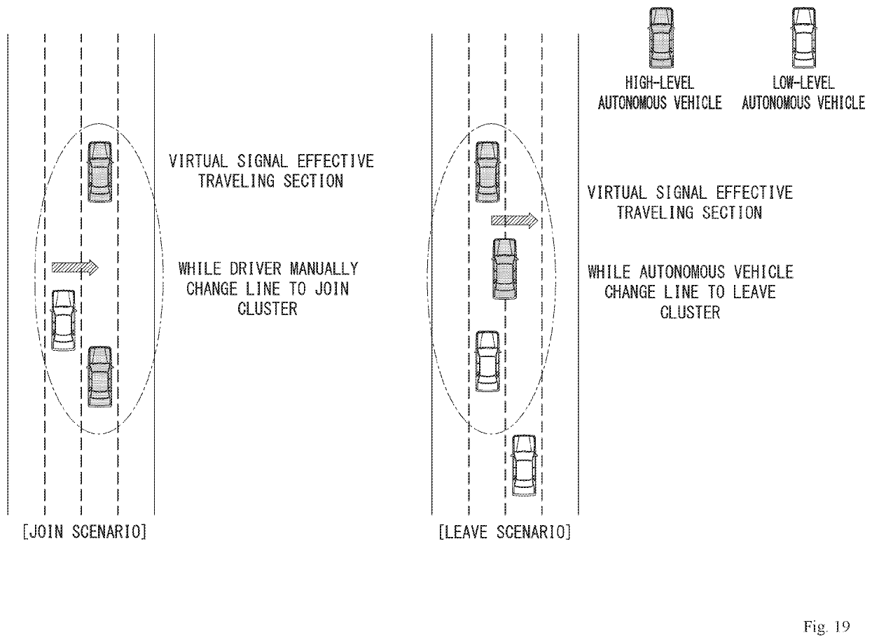

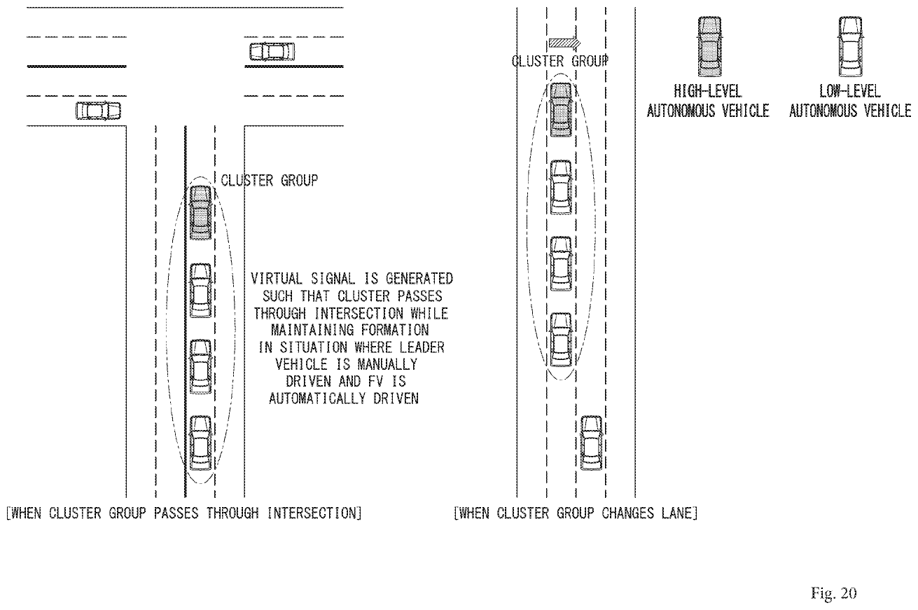

Each of FIGS. 19 and 20 is an embodiment to which the present invention is applicable.

Each of FIGS. 19 and 20 is an example in which the section is determined to the virtual traffic light information effective section when the vehicles are joined/left, change the lanes, or pass through the intersection in a cooperative adaptive cruise control (CACC) or a cluster traveling mode.

A range of the virtual traffic light information effective section can be variably set according to a peripheral traffic situation (for example, the speed of the peripheral vehicle, the number of the peripheral vehicles).

While the vehicle initially approaching the virtual traffic light effective section passes through the section, it is possible to determine whether one or more vehicles approach the effective section based on the V2V message. When it is expected that the vehicle approaches the range of the effective section, a virtual traffic light service request message can be transmitted to the server.

The server can charge one of a vehicle existing outside the virtual signal effective section or a vehicle existing in the virtual signal effective section. For example, the vehicle initially recognizing approaching of other vehicles may be the server, and when the vehicle playing the role of the server leaves the effective section, the role of the server can be entrusted to other vehicles in the effective section.

For example, in a case where a leader vehicle is manually driven and a cluster of vehicles automatically travels in cluster traveling, the virtual traffic light information may be generated such that the cluster of the vehicles maintains a formation and passes through the intersection.

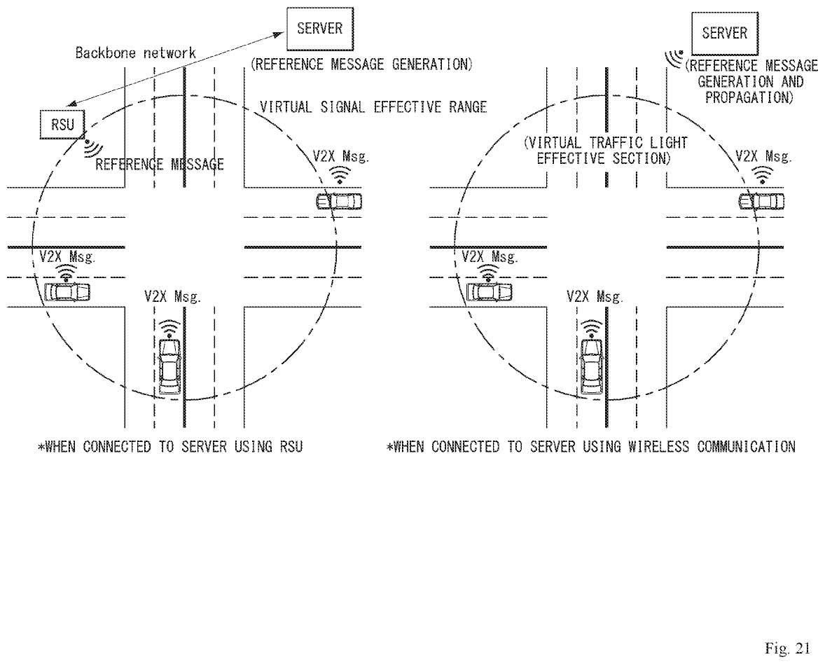

FIG. 21 is an embodiment in which the virtual traffic light information is transmitted through the server at the intersection.

When it is determined that the virtual traffic light service needs to start in the vehicle, a vehicle initially recognizing the necessity transmits the virtual traffic light service request message to the server. The vehicles entering the virtual traffic light service effective section can inform this to the server.

The server can propagate a reference message for the virtual traffic light service to the virtual traffic light effective section or propagate the reference message while the traveling vehicle exist in the effective section. For this, the RSU may be used.

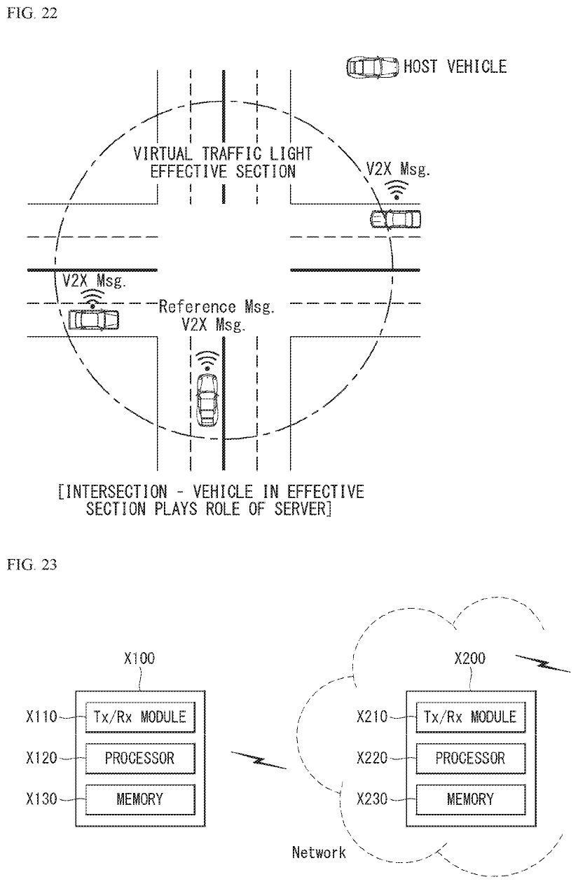

FIG. 22 is an embodiment in which the virtual traffic light information is transmitted through the host vehicle at the intersection.

In the above-described embodiments, the role of the server can be executed through the host vehicle, the host vehicle can be designated to the vehicle initially entering the virtual traffic light effective section among the autonomous vehicles, and when the host vehicle leaves the effective section, the host vehicle may be assigned to a subordinate vehicle.

Device to which Present Invention is Applicable

Referring to FIG. 23, a server X200 according to a proposed embodiment may include a communication module X210, a processor X220 and a memory X230. The communication module X210 is referred to as a radio frequency (RF) unit. The communication module X210 can be configured to transmit various signals, data, and information to an external device, and to receive various signals, data, and information from the external device. The server X200 can be connected to the external device in wired and/or wireless manner. The communication module X210 can be implemented to be divided into a transmission unit and a receiving unit. The processor X220 can control all operations of the server X200, and the server X200 can be configured to execute a function of computing information or the like to be transmitted and received to and from the external device. In addition, the processor X220 can be configured to execute a server operation provided by the present invention. The processor X220 can control the communication module X110 to transmit data or a message to the UE, other vehicles, or other servers based on a proposal of the present invention. The memory X230 can save arithmetically processed information or the like during a specified period of time, and can be replaced with a component such as a buffer.

Moreover, the specific configurations of the terminal device X100 and the server X200 as described above can be implemented such that contents described in the above-described various embodiments of the present invention are independently applied or two or more embodiments are applied at the same time, and overlapping contents are omitted for clarity.

### EMBODIMENTS TO WHICH THE PRESENT INVENTION IS APPLICABLE

### Embodiment 1

A method for providing a virtual traffic light service to a first vehicle in automated vehicle & highway systems, the method including: receiving a reference message for generating virtual traffic light information; receiving a V2X message from a second vehicle or a road side unit (RSU) using V2X communication: determining whether the second vehicle enters an effective section requiring a travel using the virtual traffic light information, using the reference message or the V2X message; and generating the virtual traffic light information when the second vehicle enters the effective section, in which the virtual traffic light information includes a traffic light signal for a cooperative travel of the first vehicle and the second vehicle in the effective section.

### Embodiment 2

In Embodiment 1, the reference message includes road information in the effective section, a priority value of a road based on the road information, information of a vehicle traveling in the effective section, a priority value of the vehicle traveling in the effective section, or policy information applied to the travel using the virtual traffic light information.

### Embodiment 3

In Embodiment 2, the priority value of the vehicle is based on a reference point located in the effective section or a drive purpose of the vehicle.

### Embodiment 4

In Embodiment 1, when the first vehicle is a vehicle which does not support an autonomous traveling, the virtual traffic light information is displayed for a user of the first vehicle.

### Embodiment 5

In Embodiment 2, the policy information includes first entering vehicle priority policy information that a vehicle first entering the effective section has priority, traffic flow improvement priority policy information for improving a traffic flow in the effective section, or emergency vehicle priority policy information that an emergency vehicle has priority.

### Embodiment 6

In Embodiment 5, when the policy information is the first entering vehicle priority policy information, the generating of the virtual traffic light information includes generating the virtual traffic light information including the traffic light signal for allowing a vehicle having a high priority value based on a road determined to be in a travelable status based on the road information to pass through the effective section first.

### Embodiment 7

In Embodiment 5, when the policy information is the traffic flow improvement priority policy information, the generating of the virtual traffic light information includes setting the priority value of a road such that the road requiring a traffic flow improvement based on the road information has priority, and generating the traffic light information including the traffic light signal for allowing a vehicle on the road having a high priority value based on the priority value of the road to pass through the effective section first.

### Embodiment 8

In Embodiment 1, when the second vehicle is determined to be a vehicle which does not travel using the virtual traffic light information, through the V2X message, the first vehicle urgently stops or a warning message is displayed for a user of the first vehicle.

### Embodiment 9

Embodiment 1, when the first vehicle travels in a state of a cluster, the effective section indicates a section in which the first vehicle leaves from a cluster-traveling.

### Embodiment 10

In Embodiment 1, when a cluster-traveling is required for the first vehicle, the effective section indicates a section joined to the cluster-traveling.

### Embodiment 11

In Embodiment 2, the first vehicle travels in a state of the cluster, the priority value of the first vehicle is based on the number of vehicles constituting a cluster for the cluster-traveling.

### Embodiment 12

A method for providing a virtual traffic light service of a server in automated vehicle & highway systems, the method including: acquiring road information of a section monitored by the server through a reception of a request message for a virtual traffic light service from a vehicle or map information: determining whether to start the virtual traffic light service based on the request message or the road information: setting an effective section requiring a travel using virtual traffic light information for the virtual traffic light service: and transmitting a reference message for generating the virtual traffic light information, in which the effective section is set to a region having a predetermined distance range based on an event occurrence point requiring a travel using the virtual traffic light information, and the reference message is transmitted via a broadcast mode in the effective section.

### Embodiment 13

In Embodiment 12, the determining of whether to start the virtual traffic light service includes determining the start of the virtual traffic light service when an intersection section, a ramp section, or a construction section occurs based on the road information, or when an operation for a cluster-traveling of the vehicle occurs based on the request message.

### Embodiment 14

In Embodiment 13, the operation for the cluster-traveling of the vehicle includes an operation when a cluster to which the vehicle belongs passes through an intersection or an operation when the cluster changes a lane.

### Embodiment 15

In Embodiment 12, the reference message includes road information in the effective section, a priority value of a road based on the road information, information of a vehicle traveling in the effective section, a priority value of the vehicle traveling in the effective section, or policy information applied to the travel using the virtual traffic light information.

### Embodiment 16

In Embodiment 15, the priority value of the vehicle is based on a reference point located in the effective section or a drive purpose of the vehicle.

### Embodiment 17

In Embodiment 12, the server includes a host vehicle including an application executing the virtual traffic light service.

### Embodiment 18

In Embodiment 12, the method further includes receiving a V2X message using V2X communication from the vehicle through a PC5, updating the reference message based on the V2X message, and transmitting the updated reference message, in which the V2X message includes status information of the vehicle or road information in the effective section.

### Embodiment 19

In Embodiment 12, the transmitting of the reference message includes transmitting the reference message while a vehicle traveling the effective section exists.

### Embodiment 20

In Embodiment 18, the predetermined distance range is reset according to a degree of an attention required to a user based on the road information.

### Embodiment 21

A server for providing a virtual traffic light service of the server in automatic vehicle & highway systems, the server includes: a communication module; a memory; and a processor, the processor receives a request message of the virtual traffic light service from a vehicle using the communication module or acquires road information of a section monitored by the server through map information, determines whether to start the virtual traffic light service based on the request message or the road information, sets an effective section requiring a travel using virtual traffic light information through the virtual traffic light service, and transmits a reference message for generating the virtual traffic light information, and the reference message includes road information of the effective section.

The above-described present invention can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Furthermore, although the invention has been described with reference to the services and the exemplary embodiments, the services and the embodiments are only examples and do not limit the present invention. Moreover, those skilled in the art will appreciate that various modifications and variations can be made in the present invention without departing from the spirit or scope of the invention described in the appended claims. For example, each component described in detail in embodiments can be modified. In addition, differences related to such modifications and applications should be interpreted as being included in the scope of the present invention defined by the appended claims.

The present invention is described with reference to the example applied to the automated vehicle & highway systems based on the 5G (5 generation) system. However, the present invention can be applied to various wireless communication systems and autonomous traveling devices.

According to an embodiment, it is possible to provide the method and the apparatus for generating the virtual traffic light in the automated vehicle & highway systems.

According to an embodiment, it is possible to provide the method and the apparatus for generating the virtual traffic light and processing information of the virtual traffic light in the automated vehicle & highway systems.

Effects obtained in the present invention are not limited to the effects mentioned above, and other effects not mentioned can be clearly understood by a person skilled in the art from the above descriptions.

What is claimed is:

1. A method for providing a virtual traffic light service to a first vehicle in automated vehicle & highway systems, the method comprising:
receiving a reference message for generating virtual traffic light information;
receiving a V2X message from a second vehicle or a road side unit (RSU) using V2X communication;
determining whether the second vehicle enters an effective section requiring a travel using the virtual traffic light information, using the reference message or the V2X message; and
generating the virtual traffic light information when the second vehicle enters the effective section, wherein
the virtual traffic light information includes a traffic light signal for a cooperative travel of the first vehicle and the second vehicle in the effective section.

2. The method of claim 1, wherein the reference message includes road information in the effective section, a priority value of a road based on the road information, information of a vehicle traveling in the effective section, a priority value of the vehicle traveling in the effective section, or policy information applied to the travel using the virtual traffic light information.

3. The method of claim 2, wherein the priority value of the vehicle is based on a reference point located in the effective section or a drive purpose of the vehicle.

4. The method of claim 1, wherein when the first vehicle is a vehicle which does not support an autonomous traveling, the virtual traffic light information is displayed for a user of the first vehicle.

5. The method of claim 2, wherein the policy information includes first entering vehicle priority policy information that a vehicle first entering the effective section has priority, traffic flow improvement priority policy information for improving a traffic flow in the effective section, or emergency vehicle priority policy information that an emergency vehicle has priority.

6. The method of claim 5, wherein when the policy information is the first entering vehicle priority policy information, the generating of the virtual traffic light information includes generating the virtual traffic light information including the traffic light signal for allowing a vehicle having a high priority value based on a road determined to be in a travelable status based on the road information to pass through the effective section first.

7. The method of claim 5, wherein when the policy information is the traffic flow improvement priority policy information, the generating of the virtual traffic light information includes setting the priority value of a road such that the road requiring a traffic flow improvement based on the road information has priority, and generating the traffic light information including the traffic light signal for allowing a vehicle on the road having a high priority value based on the priority value of the road to pass through the effective section first.

8. The method of claim 1, wherein when the second vehicle is determined to be a vehicle which does not travel using the virtual traffic light information, through the V2X message, the first vehicle urgently stops or a warning message is displayed for a user of the first vehicle.

9. The method of claim 1, wherein when the first vehicle travels in a state of a cluster, the effective section indicates a section in which the first vehicle leaves from a cluster-traveling.

10. The method of claim 1, wherein when a cluster-traveling is required for the first vehicle, the effective section indicates a section joined to the cluster-traveling.

11. The method of claim 2, wherein when the first vehicle travels in a state of a cluster, the priority value of the first vehicle is based on the number of vehicles constituting the cluster for the cluster-traveling.

12. A method for providing a virtual traffic light service of a server in automated vehicle & highway systems, the method comprising:
acquiring road information of a section monitored by the server through a reception of a request message for a virtual traffic light service from a vehicle or map information;
determining whether to start the virtual traffic light service based on the request message or the road information;
setting an effective section requiring a travel using virtual traffic light information for the virtual traffic light service; and
transmitting a reference message for generating the virtual traffic light information, wherein
the effective section is set to a region having a predetermined distance range based on an event occurrence point requiring a travel using the virtual traffic light information, and
the reference message is transmitted via a broadcast mode in the effective section.

13. The method of claim 12, wherein the determining of whether to start the virtual traffic light service includes determining the start of the virtual traffic light service when an intersection section, a ramp section, or a construction section occurs based on the road information, or when an operation for a cluster-traveling of the vehicle occurs based on the request message.

14. The method of claim 13, wherein the operation for the cluster-traveling of the vehicle includes an operation when a cluster to which the vehicle belongs passes through an intersection or an operation when the cluster changes a lane.

15. The method of claim 12, wherein the reference message includes road information in the effective section, a priority value of a road based on the road information, information of a vehicle traveling in the effective section, a priority value of the vehicle traveling in the effective section, or policy information applied to the travel using the virtual traffic light information.

16. The method of claim 15, wherein the priority value of the vehicle is based on a reference point located in the effective section or a drive purpose of the vehicle.

17. The method of claim 12, wherein the server includes a host vehicle including an application executing the virtual traffic light service.

18. The method of claim 12, further comprising:
receiving a V2X message using V2X communication from the vehicle through a PC5;
updating the reference message based on the V2X message; and
transmitting the updated reference message, wherein
the V2X message includes status information of the vehicle or road information in the effective section.

19. The method of claim 12, wherein the transmitting of the reference message includes transmitting the reference message while a vehicle traveling the effective section exists.

20. The method of claim 18, wherein the region having a predetermined distance range is reset according to a degree of an attention required to a user based on the road information.
